(19) United States
(12) Patent Application Publication
(10) Pub. No.: US 2009/0264147 A1
(43) Pub. Date: Oct. 22, 2009

(54) TELEPHONE TERMINAL AND SIGNAL PROCESSING METHOD

(76) Inventors: Jun Kuroda, Tokyo (JP); Yukio Murata, Tokyo (JP); Ukyou Mori, Tokyo (JP)

Correspondence Address: NEC CORPORATION OF AMERICA, 6535 N. STATE HWY 161, IRVING, TX, 75039, US

(21) Appl. No.: 12/091,534

(22) PCT Filed: Oct. 26, 2006
(86) PCT No.: PCT/JP2006/321374

§ 371 Date: Apr. 25, 2008

(30) Foreign Application Priority Data
Oct. 26, 2005 (JP) 2005-311278

(51) Int. Cl. H04M 1/00

(52) U.S. Cl. 455/550.1; 379/419

(57) ABSTRACT

A telephone terminal (10) includes: an operation unit (11) inputting an operation signal corresponding to an operation of a user; a sound input unit (16) inputting a sound signal corresponding to sound captured from an outside; a signal processing unit (14) converting the sound signal from the sound input unit to a transmission signal; a control unit (15) interrupting propagation of the sound signal inputted to the signal processing unit at the time when the operation signal from the operation unit is recognized. With the configuration, sound generated by a terminal operation such as a key operation during a telephone call in a telephone terminal can be easily prevented from being sent to the other party.

### TECHNICAL FIELD

The present invention relates to signal processing of a telephone terminal and, more particularly, to processing of a sound signal input to a telephone terminal being used for a telephone call.

### BACKGROUND ART

Hitherto, a telephone terminal such as a cellular phone or a fixed-line telephone has various operation means such as a key button and a change-over switch. Depending on mechanical structures of the operation means or the structure of a terminal casing, large vibration and sound occur during an operation. In the case where such vibration and sound occur during a telephone call, there is a case that they propagate in the casing and space and are captured by a microphone of the terminal. Signals of the captured vibration and sound are transmitted to a telephone line and, as a result, an inconvenience occurs such that the other party of the telephone call hears unpleasant sound.

For example, as a technique for solving the inconvenience, there is a technique described in patent document 1 which will be described. In the patent document 1, a sound input device that eliminates components of an operation sound as noise from sound entered during a key operation detection period is provided. The device detects a signal interval in which components of an operation sound are added to a digital signal of input sound and performs a process of interpolating the interval with a sound signal to which the components of the operation sound are not added.

[Patent document 1] Japanese Patent Application Laid-Open No. 2003-295899

### DISCLOSURE OF THE INVENTION

### Problems to be Solved by the Invention

By the method described in the patent document 1, by removing noise caused by a key operation, the sound quality can be improved. However, to realize the function, complicated digital processing is necessary for an input sound signal. Therefore, in the case of providing a telephone terminal with the function, increase in the product cost of the terminal is concerned.

Although transmission of noise caused by an operation during a telephone call has to be prevented, inherently, an operation during a telephone call is an operation of relatively low frequency such as a change in a reception call volume or a response to a call from a third party. It is therefore undesirable from the viewpoint of sales that the manufacture cost increases due to such an operation.

The present invention has been achieved in view of the problem and an object of the invention is to provide a method capable of easily preventing noise caused by an operation on a telephone terminal being used for a telephone call from being transmitted to the other party.

### Means for Solving the Problem

A telephone terminal according to the present invention includes: an operation unit inputting an operation signal corresponding to an operation of a user; a sound input unit inputting a sound signal corresponding to sound captured from an outside; a signal processing unit converting the sound signal from the sound input unit to a transmission signal and transmitting the transmission signal to a telephone line; and a control unit interrupting propagation of the sound signal inputted to the signal processing unit at the time when the operation signal from the operation unit is recognized.

A signal processing method of the invention is a method, for a telephone terminal being in a communication state where the telephone terminal converts a sound signal corresponding to sound captured from an outside to a transmission signal and transmits said transmission signal to a telephone line, comprising a step of interrupting propagation of the sound signal in the telephone terminal.

### Effect of the Invention

According to the invention, sound caused by an operation on a telephone terminal during a telephone call can be easily prevented from being transmitted. Therefore, the other party can be prevented from hearing unpleasant sound.

### BRIEF DESCRIPTION OF DRAWINGS

FIG. 1 is a Block diagram showing a basic configuration of an embodiment of a telephone terminal according to the present invention;

FIG. 2 is a drawing of the appearance of a cellular phone terminal of an embodiment;

FIG. 3 is a flowchart showing operation procedure of a first embodiment;

FIG. 4 is a flowchart showing operation procedure of a second embodiment;

FIG. 5 is a block diagram showing the configuration of a specific example (No. 1) of the embodiment;

FIG. 6 is a block diagram showing the configuration of a specific example (No. 2) of the embodiment; and

FIG. 7 is a block diagram showing the configuration of a specific example (No. 3) of the embodiment;

### DESCRIPTION OF REFERENCE NUMERALS

10 cellular phone terminal
11 key buttons
12 display
13 speaker
14 signal processing circuit
15 CPU
16 microphone
17 analog amplifier
18 A/D converter
19 buffer
20 digital amplifier
21 effector
22 AMR encoder
23 RF circuit
24 antenna
25 selector

### BEST MODES FOR CARRYING OUT THE INVENTION

Embodiments of the present invention will be described in detail with reference to the drawings. The embodiments described below relate to modes of applying the present invention to a cellular phone terminal.

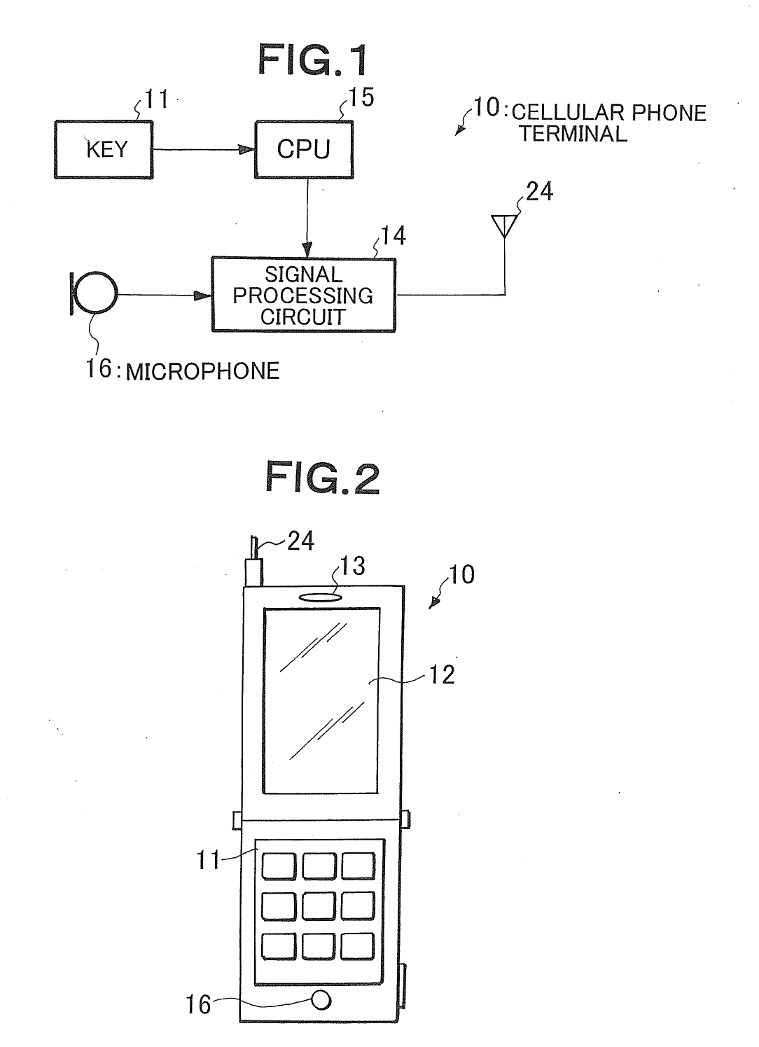

FIG. 1 shows the basic configuration of a cellular phone terminal 10 of a first embodiment. As shown in FIG. 1, the cellular phone terminal 10 has key buttons 11 corresponding to an operation unit of the telephone terminal of the invention, a microphone 16 corresponding to a sound input unit, a CPU (Central Processing Unit) 15 corresponding to a control unit, and a signal processing circuit 14 corresponding to a signal processing unit and performing radio communication via an antenna 24.

FIG. 2 shows the appearance of the cellular phone terminal 10. The appearance of the cellular phone terminal 10 is similar to that of a general cellular phone terminal. Specifically, as shown in FIG. 2, the cellular phone terminal 10 has the antenna 24 provided at the end of the casing, a speaker 13 as receiving means, a display 12 as display means, the key buttons 11, and the microphone 16.

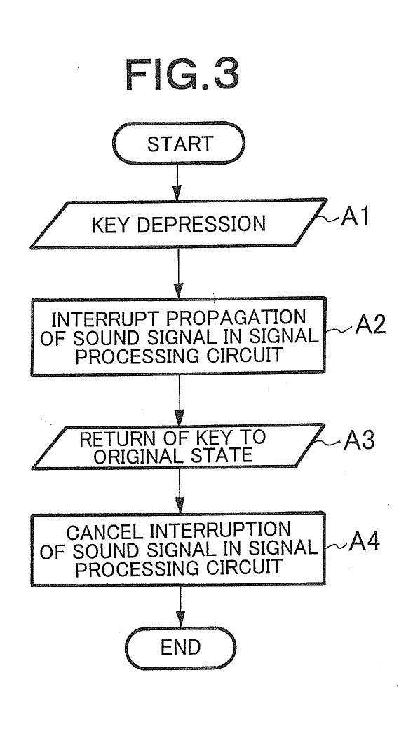

With reference to the flowchart of FIG. 3, the operation of the cellular phone terminal 10 will be described. The operation procedure shown in the flowchart to be referred to below corresponds to operations performed when a program stored in not-shown storing means of the cellular phone terminal 10 is executed by the CPU 15.

First, when the user depresses a key button 11 to perform adjustment of telephone receiving sound volume or the like while the cellular phone terminal 10 is in a communication state, a key depression operation signal is input by a control device of the key button 11. As a result, the CPU 15 recognizes that a key depression interrupting process is generated (step A1). In the case where sound caused by depression of the key button 11 is captured by the microphone 16, a sound signal of the sound is supplied from the microphone 16 to the signal processing circuit 14.

When depression of the key button 11 is recognized, the CPU 15 supplies a signal for interrupting propagation of the sound signal input from the microphone 16 to the signal processing circuit 14 (step A2). The signal processing circuit 14 that receives the signal stops the operation or operates so as to invalidate the sound signal from the microphone 16.

Subsequently, when the user releases the key button 11, the CPU 15 recognizes generation of an interruption process indicative of return of the key to the original state (step A3). When return of the key to the original state is recognized, the CPU 15 supplies a signal for cancelling interruption of a sound signal to the signal processing circuit 14 (step A4). In response to the signal, propagation of the sound signal from the microphone 16 restarts in the signal processing circuit 14.

In the first embodiment, on recognition of operation of the key button 11, the CPU 15 controls so as to interrupt propagation of the sound signal in the signal processing circuit 14. Therefore, transmission of a sound caused by a key operation can be easily prevented. In addition, a propagation restart timing is associated with the return operation inevitably accompanying the depressing operation, so that the control of the CPU 15 can be simplified.

A second embodiment of the present invention will now be described. In the embodiment, so-called long-depression operation of continuously depressing the key button 11 for a predetermined period is considered. The difference between the second embodiment and the first embodiment is the control procedure of the CPU 15. The hardware configuration of the cellular phone terminal 10 of the second embodiment is similar to that shown in FIGS. 1 and 2, so that the description will not be repeated.

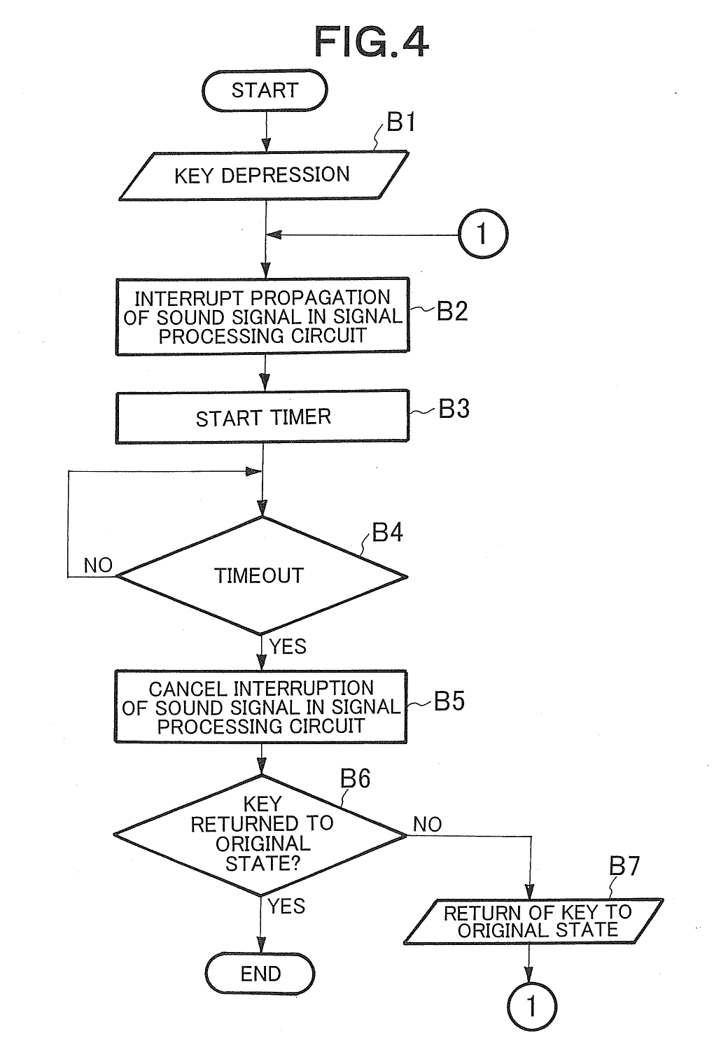

With reference to the flowchart of FIG. 4, the operation of the second embodiment will be described. When depression of the key button 11 is recognized in a communication state (step B1), the cellular phone terminal 10 gives the interruption signal to the signal processing circuit 14 (step B2). At this time, the CPU 15 starts a timer process for counting a preset period (step B3).

When completion of the timer process is recognized (Yes in step B4), the CPU 15 gives the signal of cancelling interruption of the sound signal to the signal processing circuit 14 (step B5). In response to the signal, the propagation of the sound signal in the signal processing circuit 14 restarts.

Subsequently, the CPU 15 determines the state of the depressed key button 11 (step B6). When it is recognized that the key has returned to the original state (step B7), the interruption signal is supplied again to the signal processing circuit 14 (step B2). After that, the timer process (steps B3 and B4) is performed, propagation of the sound signal is restarted (step B5), and the process is finished.

As described above, in the cellular phone terminal 10 of the embodiment, propagation of the sound signal is temporarily interrupted at both of the time point when the key button 11 is depressed, and the time point when the key has returned to the original state. The CPU 15 automatically recognizes the recovery timing after interruption by the timer process. Therefore, in the second embodiment, the sound signal interruption period can be properly controlled in uses requiring the key long-depress operation.

Next, three specific examples of the foregoing embodiments will be described with respect to the components of the signal processing circuit 14 and the control of the CPU 15 on the signal processing circuit 14. To carry out the specific examples, the layout of the signal processing circuit 14 is set in consideration of balance between propagation speed of a sound signal input from the microphone 16 and the processing speed of the CPU 15.

### CONCRETE EXAMPLE 1

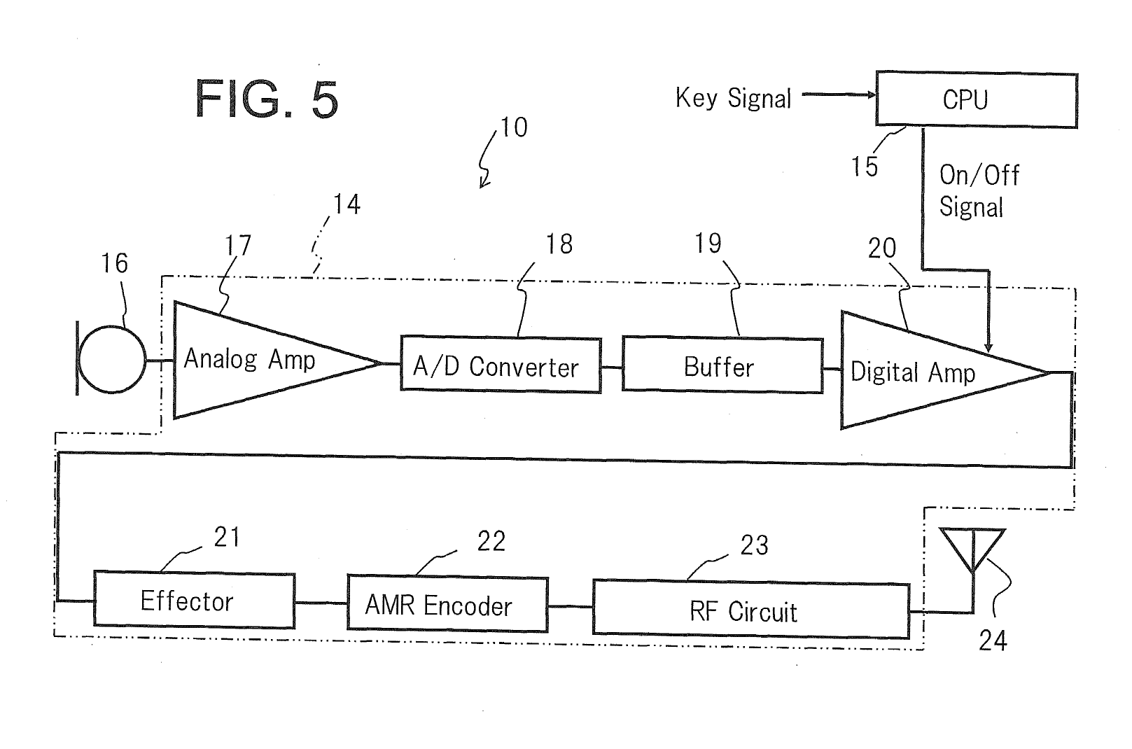

FIG. 5 shows the configuration of the cellular phone terminal 10 of a specific example (No. 1). First, components of the signal processing circuit 14 shown in the diagram will be described. An analog amplifier 17 receives an analog sound signal output from the microphone 16 and amplifies it. An A/D converter 18 converts the sound signal from the analog amplifier 17 to a digital signal. A digital amplifier 20 amplifies the digital sound signal from the A/D converter 18.

An effecter 21 performs various acoustic processes such as noise removal on the sound signal from the digital amplifier 20. An AMR encoder 22 encodes the sound signal from the effecter 21 in an AMR format. An RF circuit 23 is a communication circuit including an RF power amplifier, a frequency filter, and a switch, generates a radio transmission signal on the basis of the output of the AMR encoder 22 and transmits the signal by the antenna 24.

While the cellular phone terminal 10 having the signal processing circuit 14 is in a telephone conversation state, at the time of interrupting propagation of the sound signal from the microphone 16 (step A2 in FIG. 3 and step B2 in FIG. 4), the CPU 15 supplies a signal of stopping the operation to the analog amplifier 17. The signal is a signal for stopping the amplifying operation of the analog amplifier 17 and controlling to achieve isolation of an input/output potential in the analog amplifier 17.

At the time of cancelling interruption of the sound signal (step A4 in FIG. 3 and step B5 in FIG. 4), the CPU 15 supplies a signal for restarting the operation to the analog amplifier 17. In response to the signal, the sound signal input from the microphone 16 propagates in the signal processing circuit 14.

To stop/restart the operation of the analog amplifier 17, the power source voltage to a transistor at the output stage in the analog amplifier 17 or base or gate bias voltage is interrupted/applied. Therefore, although not shown in FIG. 5, in reality, an active element such as a transistor is inserted in a target line.

With the configuration shown in FIG. 5, even when a sound signal caused by a key operation is input from the microphone 16, the signal can be promptly interrupted before various signal processes are performed. The configuration is suitable for, for example, the cellular phone terminal 10 using the CPU 15 whose processing speed is relatively high.

### CONCRETE EXAMPLE 2

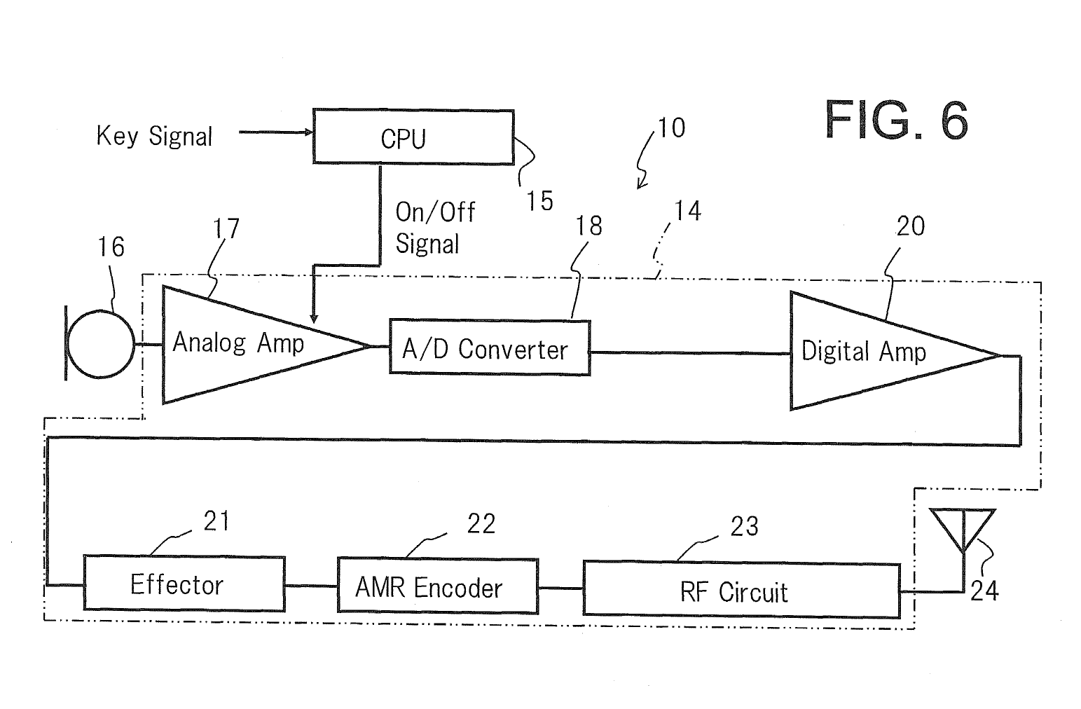

FIG. 6 shows the configuration of the cellular phone terminal 10 of a specific example (No. 2). The signal processing circuit 14 of the specific example has a configuration in which a buffer 19 for delaying propagation of the sound signal output from the A/D converter 18 is inserted in front of the digital amplifier 20. A signal for interrupting propagation of the sound signal is supplied to the digital amplifier 20. The signal is according to the signal supplied to the analog amplifier 17 in the foregoing example (No. 1).

In the configuration, when sound caused by a key operation during telephone conversation is captured by the microphone 16, the sound signal passes through the analog amplifier 17 and the A/D converter 18 and temporarily stored in the buffer 19. The sound signal accumulated in the buffer 19 before the sound signal caused by the key operation is sequentially transmitted via the digital amplifier 20 and, meanwhile, the CPU 15 performs a process of recognizing the key operation.

When the key operation is recognized, the CPU 15 gives an operation stop instruction to the digital amplifier 20 at the post stage of the buffer 19. By the instruction, even if a sound signal caused by a key operation is input from the buffer 19 to the digital amplifier 20, the input is invalidated. After that, a signal for restarting the operation is given from the CPU 15 to the digital amplifier 20, so that a sound signal propagates through the signal processing circuit 14.

As described above, in the specific example, the buffer 19 for intentionally delaying propagation of the sound signal prior to interruption of the sound signal is inserted. Therefore, the configuration shown in FIG. 6 is suitable for the case such that sufficient time cannot be assured as time of propagation from the microphone 16 to the digital amplifier 20 due to designing, or the processing speed of the CPU 15 is relatively low.

In the specific example, the sound signal interruption position is posterior to that in the configuration of FIG. 5. Consequently, the propagation of the sound signal while the CPU 15 recognizes the key operation can be delayed more. Therefore, if sufficient propagation time can be assured until the sound signal reaches the digital amplifier 20, the buffer 19 may be eliminated from the configuration shown in FIG. 6.

### CONCRETE EXAMPLE 3

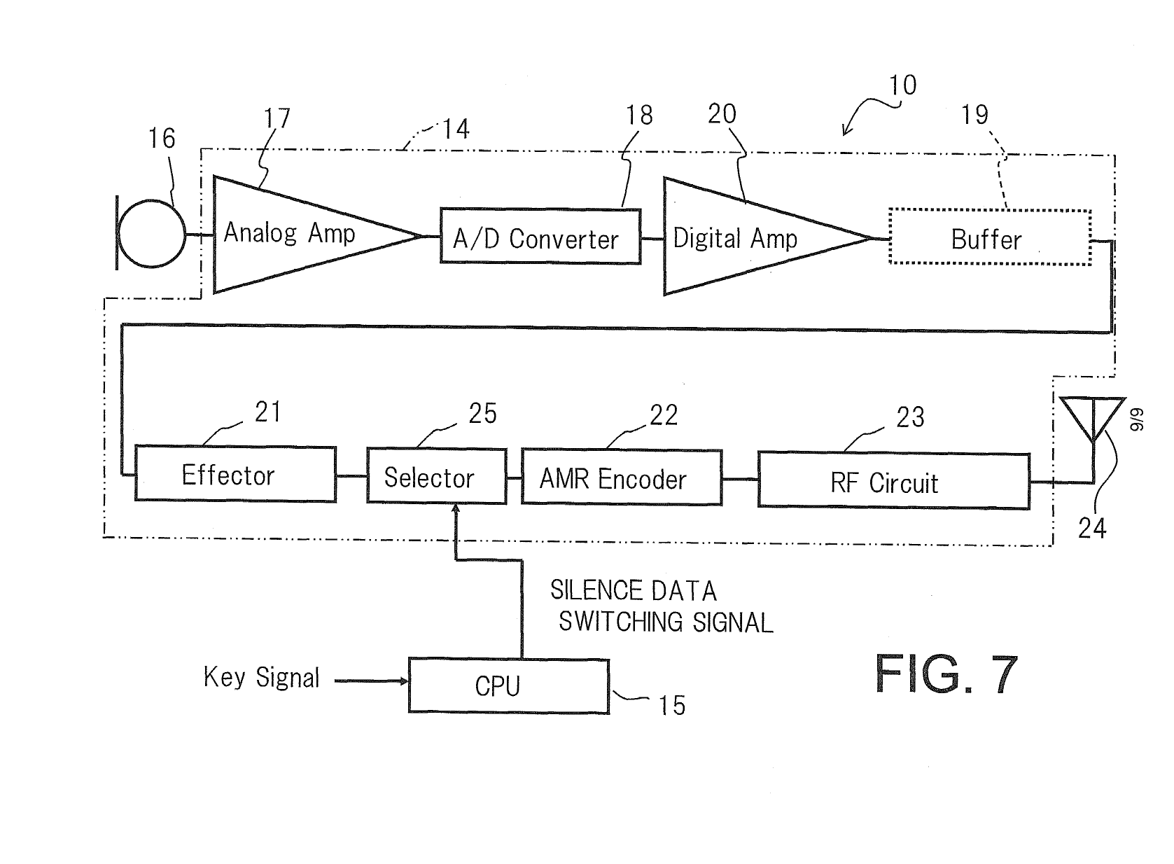

FIG. 7 shows the configuration of a cellular phone terminal 10 of a specific example (No. 3). The signal processing circuit 14 has a configuration that a selector 25 for receiving an instruction on interruption/recovery of a sound signal is inserted between the effector 21 and the AMR encoder 22 as shown in FIG. 7. The selector 25 outputs a sound signal or a sound signal of silence data from the effector 21 to the AMR encoder 22 on the basis of the instruction of the CPU 15.

In the case where the processing time of the CPU 15 on the selector 25 is longer than time required for the sound signal to reach the selector 25, that is, in the case where the sufficient propagation delay with respect to the process of the CPU 15 cannot be assured, the buffer 19 may be inserted in the signal processing circuit 14. The insertion position may be, for example, the front of the effector 21 as shown by a dotted line in FIG. 7.

On the other hand, when the buffer 19 is not inserted in the path of the sound signal, the signal processing circuit 14 can be simplified. In the layout of the signal processing circuit 14, propagation time of the sound signal from the microphone 16 to the selector 25 without the buffer 19 and time of processing of the CPU 15 on the selector 25 have to coincide with each other. Therefore, in the case where the buffer 19 is not used, the sound signal interruption position in the signal processing circuit 14 is desirably more to the back.

In the specific example, to insert the selector 25 in a position more to the back, the selector 25 is inserted between the effector 21 and the AMR encoder 22 as shown in FIG. 7. The position is a position in which the sound signal caused by the key operation is interrupted before it is encoded and also a position in which switching of a signal is performed relatively easily among backward positions.

In the configuration, at the time of interruption propagation of the sound signal from the microphone 16 (step S2 in FIG. 3 and step B2 in FIG. 4), the CPU 15 sends, to the selector 25, an instruction to output a sound signal of silence data in place of the sound signal from the effector 21. When the instruction is recognized by the selector 25, the sound signal of silence data is input to the AMR encoder 22 and encoded by the AMR encoder 22. As a result, a transmission signal of silence (which may include noise to some extent) is transmitted from the RF circuit 23.

At the time of cancelling interruption of the sound signal (step A4 in FIG. 3 and step B5 in FIG. 4), the CPU 15 instructs the selector 25 to output the sound signal from the effector 21 to the AMR encoder 22 in place of the sound signal of silence data.

In the specific example shown in FIG. 7, even if the sound signal caused by the key operation is input to the signal processing circuit 14, the sound signal can be interrupted without stopping the operation of the circuit. With the configuration in which the buffer 19 is not inserted, the signal processing circuit 14 can be simplified. It is advantageous particularly for the cellular phone terminal 10 required to have a smaller circuit.

In the foregoing embodiments, the present invention is applied to the cellular phone terminal (10). However, the invention is not limited to a wireless cellular phone terminal but can be also applied to a wired fixed-line phone terminal. Although the operation of the key button (11) is a target process in the foregoing embodiments, the target operation is not limited to the operation. Another operation accompanying generation of sound or vibration such as a switch change-over operation may be set as a target operation.

What is claimed:

1. A telephone terminal comprising:
an operation unit inputting an operation signal corresponding to an operation of a user;
a sound input unit inputting a sound signal corresponding to sound captured from an outside;
a signal processing unit converting the sound signal from the sound input unit to a transmission signal and transmitting the transmission signal to a telephone line; and
a control unit interrupting propagation of the sound signal inputted to the signal processing unit at the time when the operation signal from the operation unit is recognized.

2. The telephone terminal according to claim 1, wherein
the signal processing unit includes an amplifier which amplifies the sound signal, and
the control unit gives an instruction to stop an operation to the amplifier at the time of interrupting propagation of the sound signal.

3. The telephone terminal according to claim 2, wherein the amplifier is an amplifier which amplifies an analog sound signal output from the sound input unit.

4. The telephone terminal according to claim 2, wherein
the signal processing unit further includes a buffer for delaying propagation of a sound signal to be input to the amplifier, and
the amplifier is an amplifier which amplifies a digital sound signal from the buffer.

5. The telephone terminal according to claim 1, wherein:
the signal processing unit includes an effector which performs an acoustic process on the sound signal, an encoder which encodes the sound signal, a communication circuit which generates a transmission signal on the basis of an output of the encoder and outputs the transmission signal to a telephone line, and a selector which inputs either a sound signal from the effector or a sound signal indicating silence to the encoder; and
the control unit gives an instruction to output the sound signal indicating silence to the selector at the time of interrupting propagation of the sound signal.

6. The telephone terminal according to claim 1, wherein the control unit recognizes a signal indicating depression of a key as the operation signal and cancels the interruption at the time when a signal indicating return of said key to an original state is recognized.

7. The telephone terminal according to claim 1, wherein the control unit recognizes each of a signal indicating depression of a key and a signal indicating return of said key to the original state as the operation signal and cancels the interruption of the sound signal after a lapse of a predetermined period since said interruption.

8. The telephone terminal according to claim 1, wherein the signal processing unit includes an RF circuit which outputs a radio transmission signal to the telephone line.

9. A signal processing method, for a telephone terminal being in a communication state where the telephone terminal converts a sound signal corresponding to sound captured from an outside to a transmission signal and transmits said transmission signal to a telephone line, comprising a step of interrupting propagation of the sound signal in the telephone terminal.

10. The signal processing method according to claim 9, further comprising steps of:
recognizing a signal indicating depression of a key as the operation signal; and
canceling the interruption at the time when a signal indicating return of said key to an original state is recognized.

11. The signal processing method according to claim 9, further comprising steps of:
recognizing each of a signal indicating depression of a key and a signal indicating return of said key to the original state as the operation signal; and
canceling the interruption of the sound signal after a lapse of a predetermined period since said interruption.

12. The telephone terminal according to claim 5, wherein the control unit recognizes a signal indicating depression of a key as the operation signal and cancels the interruption at the time when a signal indicating return of said key to an original state is recognized.

13. The telephone terminal according to claim 5, wherein the control unit recognizes each of a signal indicating depression of a key and a signal indicating return of said key to the original state as the operation signal and cancels the interruption of the sound signal after a lapse of a predetermined period since said interruption.

14. The telephone terminal according to claim 5, wherein the signal processing unit includes an RF circuit which outputs a radio transmission signal to the telephone line.
